(19) United States
(12) Patent Application Publication
(10) Pub. No.: US 2014/0316970 A1
(43) Pub. Date: Oct. 23, 2014

(54) GENERATING INCOME FROM UNUSED CREDIT

(71) Applicant: Rajeshkumar Kadiwar, London (GB)

(72) Inventor: Rajeshkumar Kadiwar, London (GB)

(21) Appl. No.: 14/319,943

(22) Filed: Jun. 30, 2014

Related U.S. Application Data
(62) Division of application No. 13/452,279, filed on Apr. 20, 2012.

(51) Int. Cl. G06Q 40/02

(52) U.S. Cl. CPC G06Q 40/025
USPC 705/37

(57) ABSTRACT

A system includes one or more computers operable to electronically receive a request to deposit a first unused credit guarantee with a financial institution, and an unused credit account database configured to store the unused credit guarantee in a corresponding electronic account.

### CROSS REFERENCE TO RELATED APPLICATIONS

This application claims priority from U.S. application Ser. No. 13/452,279, filed on Apr. 20, 2012, which is incorporated herein by reference in its entirety.

### BACKGROUND

In general, credit is understood to be the trust which allows a first party to provide resources to a second party, in which the second party does not reimburse the first party immediately (thereby generating a debt), but instead arranges either to repay or return those resources (or other materials of equal value) to the first party at a later date. The resources provided may be financial (e.g., granting a loan), or they may consist of goods or services (e.g., consumer credit).

Generally, the perceived ability of a party to repay a specified amount of debt is understood to be that party's credit worthiness. A party's credit worthiness can be determined based on many factors including, for example, the party's income, how timely the party has made past payments to lenders, and the amount of outstanding debt attributed to the party, among other considerations.

### SUMMARY

The present disclosure relates to generating income from unused credit.

An innovative aspect of the subject matter described in this specification can be embodied in methods that include the actions of: electronically receiving, from one or more first computing devices, multiple requests to deposit unused credit in a deposit account, registering, using one or more processors, the unused credit associated with two or more of the requests as two or more corresponding unused credit guarantees in corresponding electronic deposit accounts, and combining the two or more unused credit guarantees into an aggregated financial guarantee.

Other embodiments of this aspect include corresponding computer systems, apparatus, and computer program products encoded on computer-readable media, each operable to cause a data processing apparatus to perform the actions of the methods. A system of one or more computers can be configured to perform particular operations or actions by virtue of having software, firmware, hardware, or a combination of them installed on the system that in operation causes the system to perform the actions. One or more computer program products can be configured to perform particular operations or actions by virtue of including instructions that, when executed by data processing apparatus, cause the apparatus to perform the actions.

The foregoing and other embodiments can each optionally include one or more of the following features, alone or in combination. For example, some embodiments can include electronically exchanging, with a second computing device, the aggregated financial guarantee in return for a payment. The payment can be selected from the group consisting of a periodic interest payment based on a value of the aggregated financial guarantee, a profit based on investment of the aggregated financial guarantee into an asset, a loan, and combinations thereof.

Some embodiments can include combining an insurance guarantee with the aggregated financial guarantee to produce an insurance-backed aggregated financial guarantee. Some implementations can include combining an asset guarantee with the aggregated financial guarantee to produce an asset-backed aggregated financial guarantee. Some implementations can include electronically issuing a payment to at least one of the first computing devices in exchange for receiving at least one of the unused credit deposits. Electronically issuing the payment can include, for example, issuing the payment to an electronic financial account associated with an entity having a credit rating on which at least a portion of the unused credit deposits is derived. Electronically issuing the payment can include, for example, issuing a loan. The loan can be an interest free loan.

Some embodiments include electronically issuing a communication to at least one of the first computing devices in exchange for receiving at least one of the unused credit deposits, in which the communication comprises a notice of a gift. Electronically exchanging the aggregated financial guarantee with the second computing device can include, for example, issuing the aggregated financial guarantee to an account associated with an unused credit guarantee repository. Registering the unused credit can include, for example, obtaining, for each request, a corresponding credit report identifying an amount of unused credit available to an entity associated with the request, comparing, using the one or more processors, the amount of unused credit available to the entity with an amount of unused credit specified in the request, and accepting the request to deposit the unused credit when the amount of unused credit available to the entity is equal to or greater than the amount of unused credit specified in the request.

Some embodiments can further include obtaining, for each request, financial information about an entity to which the unused credit of the request is available, and applying, using the one or more processors, a risk model to the financial information to obtain a risk level associated with the request.

Some embodiments further include receiving, from the one or more first computing devices, a proposed amount of unused credit to deposit, and providing, in exchange for receiving the proposed amount of unused credit, a prospective return for depositing the proposed amount of unused credit with the financial institution.

Some embodiments further include assigning a credit rating to the aggregated financial guarantee.

Some implementations further include adding a first portion of the payment to a capital reserve of a financial entity, receiving a loan backed by a second portion of the payment, and adding a portion of the loan to the capital reserve of the financial entity.

Another innovative aspect of the subject matter described in this specification can be embodied in methods that include the actions of: electronically receiving from a first computing device a request to deposit a first unused credit guarantee with a financial institution, and storing, using one or more processors, the first unused credit guarantee in a corresponding electronic account.

Other embodiments of this aspect include corresponding computer systems, apparatus, and computer program products encoded on computer-readable media, each operable to cause a data processing apparatus to perform the actions of the methods. A system of one or more computers can be configured to perform particular operations or actions by virtue of having software, firmware, hardware, or a combination of them installed on the system that in operation causes the system to perform the actions. One or more computer program products can be configured to perform particular operations or actions by virtue of including instructions that, when executed by data processing apparatus, cause the apparatus to perform the actions.

The foregoing and other embodiments can each optionally include one or more of the following features, alone or in combination. For example, some embodiments can include combining, using the one or more processors, the first unused credit guarantee with at least one additional unused credit guarantee into an aggregated financial guarantee. Some embodiments can include exchanging, with the first computing device, at least one of the aggregated financial guarantee or the first unused credit guarantee in return for a payment. The payment can be selected from the group consisting of a periodic interest payment based on a value of the aggregated financial guarantee, a profit based on investment of the aggregated financial guarantee into an asset, a loan, and combinations thereof.

Some embodiments can include combining, using the one or more processors, an insurance guarantee with the aggregated financial guarantee or the first unused credit guarantee to produce an insurance-backed unused credit guarantee.

Some embodiments can include combining, using the one or more processors, an asset guarantee with the first unused credit guarantee or the aggregated financial guarantee to produce an asset-backed unused credit guarantee.

Some embodiments can include issuing the first unused credit guarantee or the aggregated financial guarantee to an account associated with an unused credit guarantee repository.

Some implementations can include adding a first portion of the payment to a capital reserve of a financial entity, receiving a loan backed by a second portion of the payment, and adding a portion of the loan to the capital reserve of the financial entity.

Some embodiments can include, in exchange for receiving the request to deposit the first unused credit guarantee, issuing a payment to at least one electronic financial account. The at least one electronic financial account can be associated with an entity having a credit rating on which at least a portion of the unused credit is derived. The payment can include a loan. The loan can be an interest-free loan.

Some embodiments can include issuing, using the one or more processors, a communication to a computing device in exchange for receiving the request, the communication including a notice of a gift.

Some embodiments can include receiving, from the first computing device, a proposed amount of unused credit to deposit, and providing to the first computing device, in exchange for receiving the proposed amount of unused credit, a prospective return for depositing the proposed amount of unused credit with the financial institution.

Some embodiments can include assigning, using the one or more processors, a credit rating to the first unused credit guarantee.

Another innovative aspect of the subject matter described in this specification can be embodied in a system that includes a receiving module operable to electronically receive, from one or more first computing devices, a plurality of requests to deposit unused credit with a financial institution, a guarantee registration module operable to register the unused credit associated with two or more of the requests as unused credit guarantees in corresponding electronic accounts, and an aggregation module operable to combine the unused credit guarantees into an aggregated financial guarantee.

Other embodiments of this aspect include corresponding computer-implemented methods and computer program products encoded on computer-readable media, operable to cause a data processing apparatus to perform the actions of the methods. A system of one or more computers can be configured to perform particular operations or actions by virtue of having software, firmware, hardware, or a combination of them installed on the system that in operation causes the system to perform the actions. One or more computer program products can be configured to perform particular operations or actions by virtue of including instructions that, when executed by data processing apparatus, cause the apparatus to perform the actions.

Another innovative aspect of the subject mater described in this specification can be embodied in a computer-implemented method that includes the actions of electronically receiving at a first computing device, a first loan for an unused credit guarantee from a second computing device, and in exchange for receiving the first loan, issuing, using one or more processors, a second loan to an electronic financial account.

Another innovative aspect of the subject matter described in this specification can be embodied in a computer-implemented method that includes the actions of generating, using one or more processors, a synthetic unused credit guarantee based on an unused credit guarantee, in which the synthetic unused credit guarantee specifies a payment to be issued upon occurrence of a predetermined event associated with the unused credit guarantee.

Another innovative aspect of the subject matter described in this specification can be embodied in a computer-implemented method that includes the actions of electronically receiving, from a first computing device, a financial guarantee, the financial guarantee comprising at least one guarantee selected from the group consisting of an unused credit guarantee and an aggregated unused credit guarantee, appending, using one or more processors, the financial guarantee to a set of financial guarantees, and offering each of the financial guarantees in the set for purchase. The actions can further include receiving, from one or more second computing devices, a request to purchase at least one of the financial guarantees from the set of financial guarantees, and electronically exchanging the at least one financial guarantee with the one or more second computing devices in return for a payment.

Another innovative aspect of the subject matter described in this specification can be embodied in a computer-implemented method that includes the actions of electronically receiving, from one or more first computing devices, a request to deposit unused credit with a financial institution, registering, using one or more processors, the unused credit as a first unused credit guarantee in a corresponding electronic account, combining the first unused credit guarantee with a second unused credit guarantee into an aggregated financial guarantee, and electronically exchanging, with a second computing device, the aggregated financial guarantee in return for a payment.

Another innovative aspect of the subject matter described in this specification can be embodied in a computer-implemented method that includes the actions of electronically receiving, from one or more first computing devices, a request to deposit unused credit with a financial institution, issuing, in return for the unused credit, a first payment to the one or more first computing devices, registering, using one or more processors, the unused credit as a first unused credit guarantee in a corresponding electronic account, combining the first unused credit guarantee with a second unused credit guarantee into an aggregated financial guarantee, and electronically receiving a second payment, from the one or more first computing devices, in exchange for a portion of the aggregated financial guarantee corresponding to the unused credit

Another innovative aspect of the subject matter described in this specification can be embodied in a computer-implemented method that includes the actions of electronically receiving, from one or more first computing devices, a first put option contract to sell unused credit, issuing, in exchange for receiving the put option contract, a first payment to the one or more first computing devices, registering, using one or more processors, the unused credit as a first unused credit guarantee in a corresponding electronic account, combining the first unused credit guarantee with a second unused credit guarantee into an aggregated financial guarantee. In some implementations, the actions can include, for example, electronically receiving a second payment, from the one or more first computing devices, in exchange for a second put option contract to buy the unused credit.

Other embodiments of the foregoing aspects include corresponding computer systems, apparatus, and computer program products encoded on computer-readable media, each operable to cause a data processing apparatus to perform the actions of the methods. A system of one or more computers can be configured to perform particular operations or actions by virtue of having software, firmware, hardware, or a combination of them installed on the system that in operation causes the system to perform the actions. One or more computer program products can be configured to perform particular operations or actions by virtue of including instructions that, when executed by data processing apparatus, cause the apparatus to perform the actions.

The details of one or more embodiments of the invention are set forth in the accompanying drawings and the description below. Other aspects, features and advantages of the invention will be apparent from the detailed description and drawings, and from the claims.

### DESCRIPTION OF DRAWINGS

FIG. 1 is a block diagram depicting an example of how unused credit can be employed to generate income.

FIG. 2 is a schematic that depicts an example of a system for performing unused credit transactions.

FIG. 3 is a flow diagram of an example process for conducting a transaction relating to unused credit guarantees.

FIG. 4 is a schematic depicting different tranches of risk and return for a structured unused credit guarantee.

FIG. 5 is a schematic depicting an example of an arrangement for structuring unused credit guarantees.

FIG. 6 is a schematic of an arrangement for providing an aggregated unused credit guarantee.

FIG. 7 is a schematic depicting an example arrangement in which unused credit is employed to scale capital funding.

FIG. 8 is a schematic of an example arrangement for performing a sale and buy back with unused credit.

FIG. 9 is a schematic of an example arrangement for employing unused credit in option transactions.

FIG. 10 is a schematic of an example arrangement for performing a back-to-back loan with unused credit guarantees.

FIG. 11 is an example arrangement of a hybrid financial transaction employing unused credit.

FIG. 12 is a schematic of an example unused credit guarantee banking system.

FIG. 13 is an example of a screenshot from an unused credit financial transaction website.

FIG. 14 is another example of a screenshot from an unused credit financial transaction website.

### DETAILED DESCRIPTION

The present disclosure relates to leveraging the unused credit of a party (e.g., a business or individual) as a mechanism for generating income. Systems and methods can be employed that allow the party to establish a guarantee tied to unused credit. Among other things, the guarantee can be employed as a financial product that can be traded, deposited, sold, marketed, and/or aggregated with other unused credit guarantees in order to generate income.

In general, the maximum amount of debt that a debt provider is prepared to extend to a party is understood to be the party's credit limit (C_{L}) on that open line of credit from that provider. A party's credit limit is usually denominated by a unit of account such as, for example, a dollar amount. When the party converts a portion of the credit limit (e.g., by taking out a loan), the remaining amount of credit corresponds to the party's unused credit (U_{C}). Accordingly, a party's unused credit is the difference between their credit limit and the amount of credit that has been converted (C_{D}), and can be expressed as

U_{C}=C_{L}−C_{D} (1).

In some implementations, a party may have multiple lines of credit, and thus several different credit limits. Moreover, the party may be able to obtain additional line or lines of credit (potential credit) and therefore have potential unused credit (U_{CPN}). The total amount of unused credit for the party (U_{CT}) then can be expressed as the sum of the unused credit across the party's existing open credit lines, plus the potential credit i.e.,

$${U}_{CT} = {\sum }_{i = 1}^{N} {U}_{Ci} + {U}_{CPN} , \qquad ( 2 )$$

where U_{Ci} is the unused credit for the credit line i, and N is the total number of open credit lines associated with the party.

Though credit can be denominated by a unit of account, unused credit itself generally is not used as a unit of account. That is, unused credit generally is not an asset and is not reported on a balance sheet, in contrast to liquid assets (e.g., cash, commodities, securities), illiquid assets (e.g., real estate, pension benefits, royalties, mineral rights), and intangible assets (e.g., intellectual property, brand recognition). It follows that unless a party converts unused credit U_{C} (e.g., by taking out a loan), the party is unable to employ the unused credit for economic gain. Similarly, in some implementations, counterparties may exist that do not have access to sufficient credit. Such counterparties might be willing to pay a premium or provide compensation in return for access to the unused credit for their own purposes.

The subject matter described in the present specification overcomes the foregoing constraints and encompasses, among other things, mechanisms for allowing a party to monetize unused credit without requiring the party to actually transfer any cash or assets which leaves them free to continue enjoying the benefits currently being derived from them. In addition, other parties can, in return for compensation, employ the available unused credit for various purposes including, for example, increasing their own credit lines or aggregating and reselling the unused credit to others. By treating the unused credit as money, novel systems, approaches and financial instruments for generating income are possible.

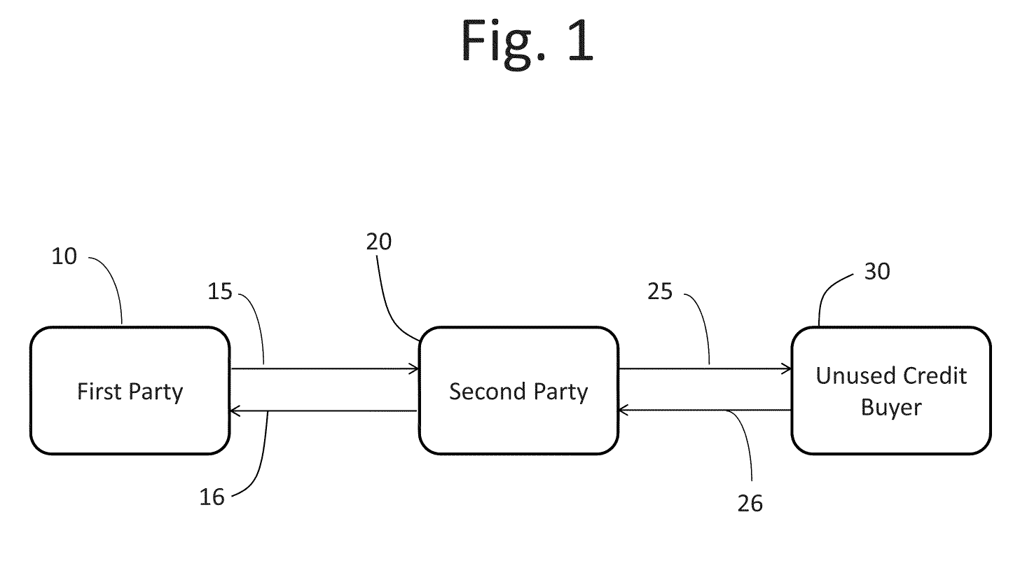

FIG. 1 is a block diagram depicting an example of how unused credit can be employed to generate income. In the example, a first party 10 provides a second party 20 with information 15 relating to unused credit associated with the first party 10. The first party 10 can be an individual, business, fund, retail investor, institutional investor (secured or unsecured), or other entity carrying unused credit. The unused credit may correspond to some or all of the credit available to the first party 10. The second party 20 in this example is a guarantor of the unused credit provided by the first party, and can include any applicable business, such as a bank, an exchange, an insurer, or a fund, among others. In other non exclusive embodiments, the first party 10 could be the guarantor of its own unused credit and the second party 20 could be a purchaser, agent or other financial intermediary of the unused credit such as a bank, an exchange, an insurer, or a fund, among others.

The information relating to unused credit provided by the first party 10 in the example embodiment of FIG. 1 can be in the form of a request to deposit the unused credit with the second party 20. When providing the unused credit 15, the first party 10 specifies an amount of unused credit to be deposited. For example, if the first party 10 has a single line of credit with a limit of $20,000, in which $10,000 of unused credit is available, the first party 10 may submit a request to deposit the unused $10,000 credit with the second party 20. In another example, the first party 10 may be determined by the second party 20 to have unused potential credit of $50,000 and the first party may deposit $30,000 of that potential unused credit with the second party 20.

Upon receiving the request 15, the second party 20 registers the unused credit in an account. For example, the second party 20 may register the unused credit as an unused credit guarantee 25, contract, or promise. Thus, the second party 20 in this non exhaustive example embodiment acts as an unused credit “promise bank” or “guarantor,” and the first part acts as a “depositor.” That is, the second party 20 converts the unused credit to the unused credit guarantee 25 and stores the unused credit guarantee 25 in an electronic unused credit guarantee repository. Other unused credit guarantees also may be stored in the repository. The requests submitted to the second party 20 do not, however, require a transfer of any actual payment. The second party 20, may in turn, structure the unused credit guarantee 25 into a financial product that can be monetized in various different ways. For example, the second party 20 can offer the unused credit guarantee 25 to a third party 30 in return for compensation 26 including, but not limited to, a fixed or variable fee, an interest payment (e.g., where the interest rate is based on the amount of unused credit), a dividend payment, or a capital gain payment. The third party 30 can include entities such as, for example, a bank, a fund, an insurer, or individual. The third party 30 can obtain the unused credit guarantee 25 through an exchange or other intermediary. Alternatively, the third party 30 can obtain the guarantee 25 through direct transfer from the second party 20. Thus, the third party 30 is an unused credit guarantee buyer in an unused credit market.

In some implementations, the second party 20 can aggregate the unused credit guarantee 25 with other unused credit guarantees. For example, the second party 20 can combine 10 unused credit guarantees, each having an unused credit value of $10,000 into an aggregated financial guarantee having a total unused credit value of $100,000. Aggregated unused credit guarantees can also be exchanged with third parties in return for compensation.

In return for depositing the unused credit with the second party 20, the first party 10 may receive compensation 16. For example, the first party 10 may receive an interest payment (e.g., where the interest rate is based on the value of the deposited unused credit), a dividend payment, a capital gain payment, cash, loan or gift, among other things. Generally, the value of compensation 16 provided to the first party 10 would be less than the compensation 26 the second party receives in return for the corresponding unused credit guarantee or an aggregated financial guarantee based in part on the unused credit provided by the first party 10.

The unused credit provided from the first party 10 can come from various sources. For example, in the case of an individual, the unused credit may correspond to the difference between the total credit allotted to an individual on a credit card and an amount that is currently borrowed on the card. Similarly, the unused credit may come from the difference between the amount of credit available to a business and any loans the business has obtained against those lines of credit. In another example, an investor manager of a fund may deposit unused credit from a limited partner in the fund. In another example, the unused credit can come from new potential unused credit available to the first party 10, where the potential unused credit corresponds to an amount defined by a difference between the maximum credit that can be made available to the first party 10 and the total amount of any actual credit lines currently open with the first party 10.

As explained above, a party's unused credit can include the difference between the party's credit limit and the amount of credit within that line that has been converted plus potential unused credit. To determine whether a party submitting a request to deposit unused credit actually has access to the value specified, the guarantor 20 can perform standard checks to assess the validity of the request. For example, in some implementations, the guarantor 20 can check with one or more credit reporting agencies (e.g., Standard & Poor's, Moody's Analytics, Fitch Ratings, Experian, TransUnion, Equifax) to confirm the amount of unused credit specified in the request 15. Alternatively, or in addition, the guarantor 20 may be able to perform its own credit assessment to evaluate the unused credit available to the requesting party 10. In some implementations, the guarantor 20 can receive additional information and evaluation reports from an underwriter to ensure the viability of the party providing the unused credit.

A “default” may occur in the transaction described above based on one or more events including, for example: if the first party 10 converts the unused credit (e.g., takes out a loan) or has the unused credit reduced (e.g., through a reduction in the first party's overall credit limit); the second party 20, which acts as the guarantor, becomes insolvent; or the third party 30 is unable to make a payment required as part of the transaction. The second party 20 can structure the unused credit guarantee 25 to reduce the risk of loss should at least one of the above events occur. For example, the unused credit guarantee 25 can be structured to include guarantee deposit insurance and/or financial guarantee insurance. The deposit insurance can be obtained from an insurer that is separate from the guarantor. Alternatively, or in addition, the unused credit guarantee 25 can be structured to include additional capital. The additional capital can be provided by the second party 20 or another investor that is separate from the guarantor. Further details on mechanisms for reducing the risk associated with an unused credit guarantee 25 will be described below.

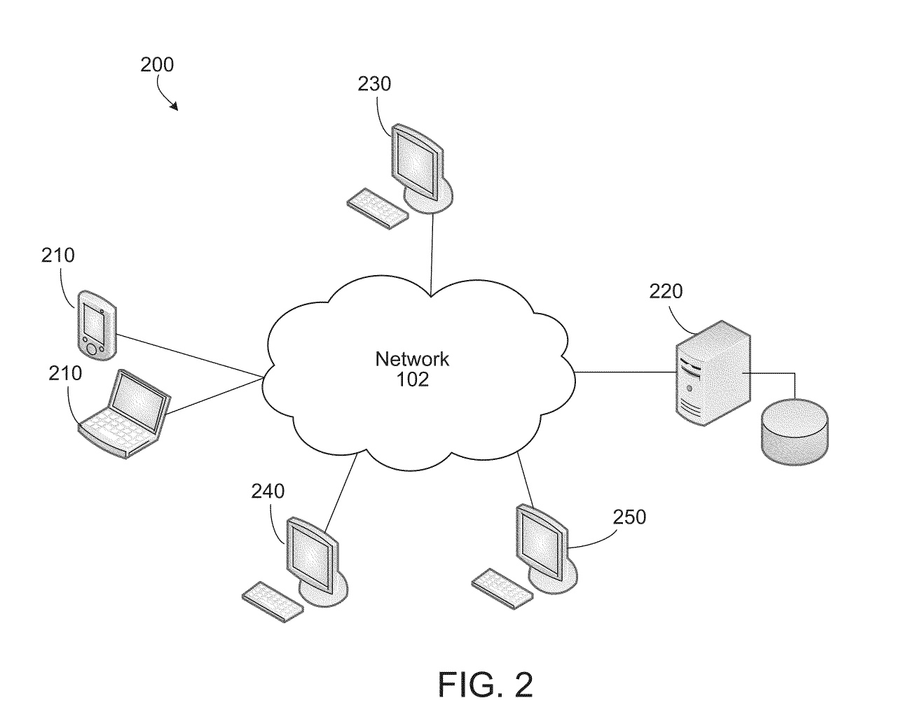

In general, the operations depicted in the example of FIG. 1 and described herein can be employed using a combination of one or more client and server devices operating across a network. FIG. 2 is a schematic that depicts an example of a system 200 for performing unused credit transactions, in which the system 200 includes client devices (210, 230, 240, 250) and one or more server devices 220. A computer network 102, such as a local area network (LAN), wide area network (WAN), the Internet, or a combination thereof, connects the client devices (210, 230, 240, 250) and server devices 220.

A client device is an electronic device that is under control of a user (e.g., a depositor, unused credit guarantee buyer, insurer, or investor), that has one or more data processing apparatuses, and that is capable of requesting, receiving and transmitting resources and/or information over the network 102. Example client devices include personal computers, mobile communication devices (e.g., smartphones or pad computing devices), and other devices that can send and receive data over the network 102. A client device can include one or more user applications, such as a web browser, to facilitate the sending and receiving of data over the network 102.

Similar to a client device, a given server device 220 includes one or more electronic processors that are capable of requesting, receiving, and transmitting resources and/or data over the network 102, in which the device 220 is under the control of a user. The server devices 220 can communicate with each other and with storage systems (e.g., databases such as customer account databases for storing customer information, guarantee repository databases for storing information regarding unused credit guarantees, or web databases for storing resources associated with a website hosted by the server device 220) at various times using one or more computer networks and/or communication devices. For example, the server devices 220 can communicate through shared memory, network communication, or other means of inter or intra-process communication. A storage system can include, for example, a database server on which data and other information is stored. The one or more server devices 220 can communicate through the network 102 with one or more of the client devices (210, 230, 240, 250).

In some implementations, the server devices 220 can be configured to host resources such as websites. An example website is a collection of web pages having one or more domain names and formatted in hypertext markup language (HTML) that can contain text, images, multimedia content, and programming elements, such as scripts for use and/or display on a client device. The client devices (210, 230, 240, 250) can request resources from and/or transmit information to the server devices 220 through websites.

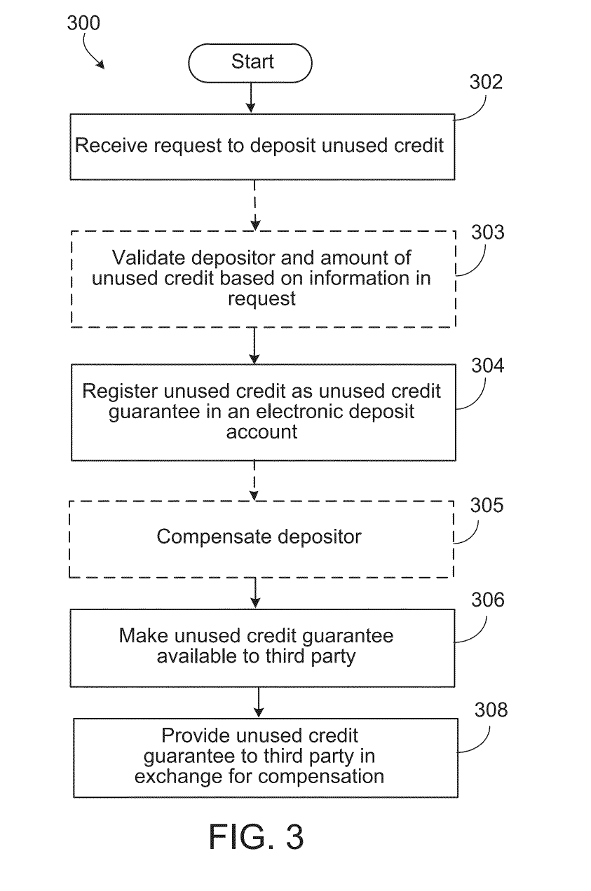

FIG. 3 is a flow diagram of an example process 300 for conducting a transaction relating to unused credit guarantees. The process 300 can be implemented in a data processing apparatus of one or more computers and memory storage systems such as the servers 220. For example, in a first operation, a server (e.g., server 220) electronically receives, from a computing device (e.g., client device 210), a request to deposit unused credit (302). The request may be sent by a first party (the “depositor”) such as an individual, business, retail investor, institutional investor, or other entity capable of providing unused credit. Various approaches may be used to send the request. For example, the request can be sent using e-mail or by submitting the request through a website. In either case, the request may specify a deposit account with which the unused credit is to be deposited, where the deposit account is associated with a particular entity. For example, the request may identify a deposit account associated with a financial institution such as a bank, an exchange, a fund, or an insurer, among other entities, as the recipient of the unused credit.

In some implementations, the request to deposit the unused credit includes additional information that may be useful in recording the deposit and later structuring an unused credit guarantee. For example, the request can include information such as the amount of unused credit to be deposited, a client account number, and/or reference information that may be useful in validating who is the depositor as well as the amount of unused credit available to the client. Upon receiving the request, the server 220 optionally validates the depositor and the amount of unused credit using the information contained in the request (303). As explained above, validation can include obtaining, for a particular request, financial information about an entity to which the unused credit of the request is available, and applying a risk model to the financial information to obtain a risk level associated with the request. If the risk level is acceptable, the depositor is validated. To validate a depositor, the server 220 can, in some implementations, check with one or more credit reporting agencies to confirm the amount of unused credit specified in the depositor's request. For example, the server 220 can obtain, for a request to deposit unused credit, a corresponding credit report identifying an amount of unused credit available to the entity associated with the request. The server 220 then can compare the amount of unused credit available to the entity with the unused credit specified in the request. If the available amount of unused credit is greater than or equal to the amount specified in the request, the server 220 can accept the request to deposit the unused credit. As another example, the server 220 may receive information directly from a range of electronic databases and websites (such as insolvency databases, births & deaths databases, industry databases and social network websites) that feed additional real time data to be used by it to calculate risk metrics. Also the server 220 may run further verification based on rules determined by its own statistical analysis of the inputs from the electronic databases, websites and client devices (e.g., 210, 230, 240, 250).

Subsequent to receiving the request and performing the optional validation, the server 220 registers the unused credit in an electronic deposit account (304) associated with the depositor. In some implementations, a deposit account is established before the unused credit can be registered. In such cases, information contained in the request may be used to establish the account such as, for example, the depositor's relevant financial information, similar to what would be required in setting up a standard checking or money market deposit account. The unused credit deposit account can be controlled and operated by a financial entity including, but not limited to, a bank, exchange or fund. In general, the unused credit deposit account is stored in a database (e.g., an unused credit deposit account database) on the server 220 or coupled to the server 220.

In general, the unused credit is registered in the deposit account as an unused credit guarantee. The unused credit guarantee corresponds to a contract, promise or assurance to provide the designated amount of unused credit to a counterparty in exchange for compensation of some kind. At this stage in the process 300, the counterparty has not been identified. Thus, the guarantee is still an “open” contract, to be closed upon completion of additional procedures, such as arranging sale of the unused credit to a counterparty. In some implementations, the details regarding the compensation due in exchange for the unused credit is still undetermined as well.

After the unused credit is registered with the deposit account, the unused credit (in the form of the guarantee) is made available for acquisition by a third party (306). For example, the server 220 can maintain a list of unused credit guarantees from which a third party is able to identify and select one or more unused credit guarantees for acquisition. In other examples the unused credit guarantees may be further structured with additional financial instruments in order to alter its financial characteristics before being marketed by the second party. In some implementations, the list is stored in a database that is part of or coupled to server 220 and/or to a database containing the unused credit deposit accounts. For example, the unused credit guarantees can be listed through a website hosted by the server 220. A third party would then access the website to review and submit requests to acquire unused credit. Alternatively, or in addition, the unused credit guarantees can be offered for sale to third parties, such as exchanges or institutional investors through other methods. The server 220 may also host tools that allow third party buyers to configure the portfolio of unused credit guarantees and additional financial products that meet third party needs. In some implementations, the server 220 can analyze the unused credit deposits to provide information to third parties, such that the third parties can use the information to request alternative marketable financial products based on the unused credit deposits. For example, by using data mining, statistical analysis or neural network techniques, the data processing apparatus of server 220 can produce various reports that provide valuable indicators including, but not limited to, volatility in a depositor's unused credit availability, and fraud detection. Alternatively, or in addition, the server 220 can be used to calculate predictive information such as identifying depositors that will be most receptive to certain marketing campaigns or identifying depositors that are likely to maintain deposits in spite of changes to rates of return or changes on risk of losses on their deposits. Alternatively, or in addition, the server 220 can be used to model the risk and volatility effects of adding certain unused credits to a portfolio. The alternative financial products can also be sold to the third parties through websites and/or databases hosted by or coupled to server 220 and also through proprietary data stored on movable storage devices. In some implementations, the server 220 may also be coupled with other servers and databases that act as central repositories of unused credits and their derivatives and counterparties. These central repositories can facilitate the monitoring and clearing of unused credit transactions between various counterparties.

When a third party has identified an unused credit guarantee or unused credit information product to be acquired, the server 220 provides the unused credit guarantee to the third party in exchange for compensation (308). For example, the third party can submit compensation to the server 220 in the form of a payment (e.g., cash payment, interest payment, dividend payment, or capital gain payment). The payment can be made electronically from a client device (e.g., client device 230) over the network 102 to the server 220 (e.g., by wire transfer). The payments can be submitted to a financial account associated with the party operating the server 220. The payments can be made in a single installment or over multiple installments. Once the third party has acquired the unused credit guarantee, the third party then is able to employ the unused credit including, for example, to obtain additional loans, or make purchases.

In general, the depositor expects compensation of some kind in return for depositing the unused credit. The compensation can optionally be provided directly after the unused credit is deposited with the unused credit account or sometime thereafter. As shown in FIG. 3, the server 220 optionally compensates the depositor (305) after the unused credit is deposited in the account. Compensation can take various forms including, for example, cash payments, interest-free loans, dividend payments, capital gain payments, gift cards, or consumables. In an example, the server 220 is configured to cause an electronic deposit of a cash payment to a financial account (e.g., a checking account, a money market account, a savings account) associated with the depositor or with a beneficiary nominated by the depositor, such as a charity. The electronic financial account is separate from the unused credit deposit account and may be maintained by the same financial institution that maintains the unused credit deposit account. Payment can include, for example, an interest payment, a dividend payment, or a capital gains payment. The payment can be issued electronically from the server 220 (or from a financial account associated with the party operating server 220) over a network 102 to the financial account associated with the depositor (e.g., by wire transfer). The financial account may be maintained by one or more of client devices 210 or alternatively, the financial account may be maintained by one or more client devices operated by the financial institution with which the financial account is associated. To issue the payment, the server 220 may require information regarding the financial account to which the payment will be made, such as a financial account number, a financial institution name, and/or a routing number associated with the financial institution. In some cases, the financial information may be contained in the unused credit deposit request, such that the server 220 retrieves the request. In some cases, the server 220 may retrieve the financial information from a separate database (e.g., client account database).

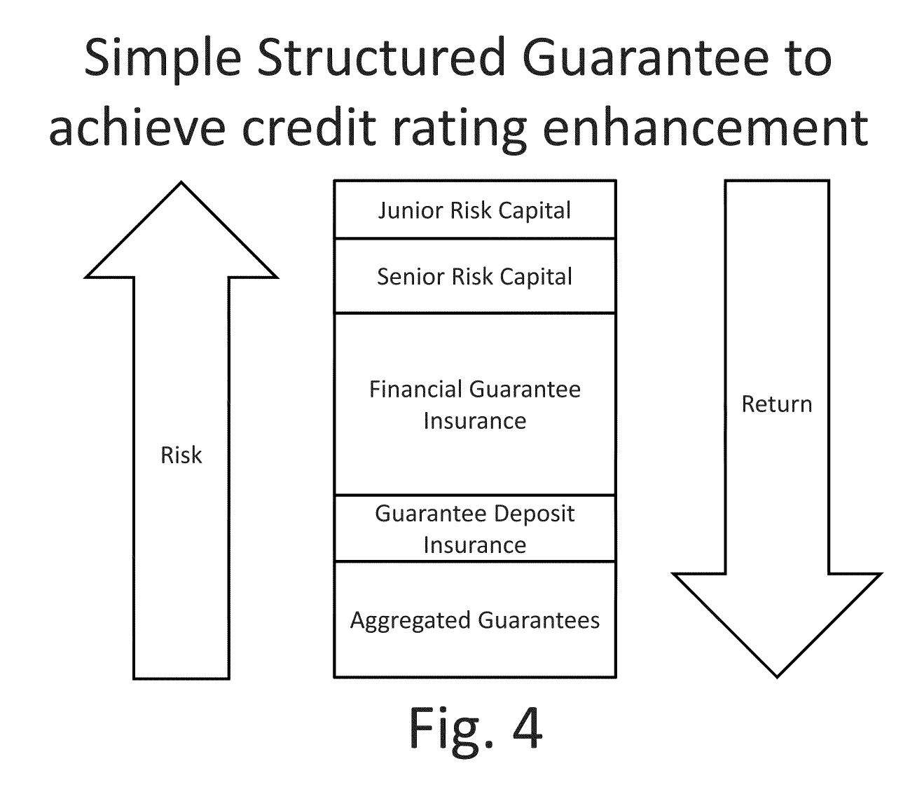

Multiple variations of the process 300 may be implemented. For example, in some implementations, a guarantor may structure an unused credit guarantee to reduce risk and improve return. Enhancing the security of an unused credit guarantee can entail, for example, purchasing insurance on the guarantee and/or adding capital to the unused credit guarantee to reduce the risk of lost income in the event a party defaults on the guarantee or the guarantor enters bankruptcy. In some implementations, the guarantor does not register unused credit from a depositor as a guarantee. Instead, the guarantor receives unused credit already in the form of an unused credit guarantee from the depositor. Alternatively, or in addition, a guarantor can combine multiple unused credit guarantees together into a single aggregated unused credit guarantee. An aggregated unused credit guarantee leverages the value of multiple individual unused credit guarantees while reducing the risk of loss due to a single depositor. Thus, unused credit guarantees can be structured in various ways to reduce risk and enhance return. FIG. 4 is an example schematic depicting different tranches of risk and return for a structured unused credit guarantee. In this example, multiple unused credit guarantees have been selected based on their characteristics and aggregated. This aggregated portfolio of unused credits is then combined with risk capital and insurance. The resulting combination is then divided into tranches of value that each have different rules on how risk is to be shared and hence normally have different returns. Hence in the example structuring of FIG. 4, the top tranche is the junior risk capital, so called because it will normally be the first to incur losses in the structure, should a loss occur. It will also normally have the highest return to compensate for the additional risk as compared to the other tranches. The next tranche is the senior risk capital which, once losses have fully depleted the junior risk capital, is next in line to incur a loss. Because it is less risky than the junior capital it receives a lower rate of return. The next tranches in the structure are the insurance tranches. The financial guarantee insurance tranche protects the structure from losses caused by defaults of the first parties 10 and/or the third parties 30. The Guarantee deposit insurance protects the first party 10 from losses caused by defaults of the second party 10. Once these insurances have also been fully depleted by losses then the losses are divided by some agreed rules between the aggregated unused credit providers. The example structure of FIG. 4 is not exhaustive and many variations are possible and their characteristics may be modeled on and computed by the server 220. The server 220 may also monitor and provide timely reports to the first party 10 and/or the third party 30 about the actual and expected future performance of the structure.

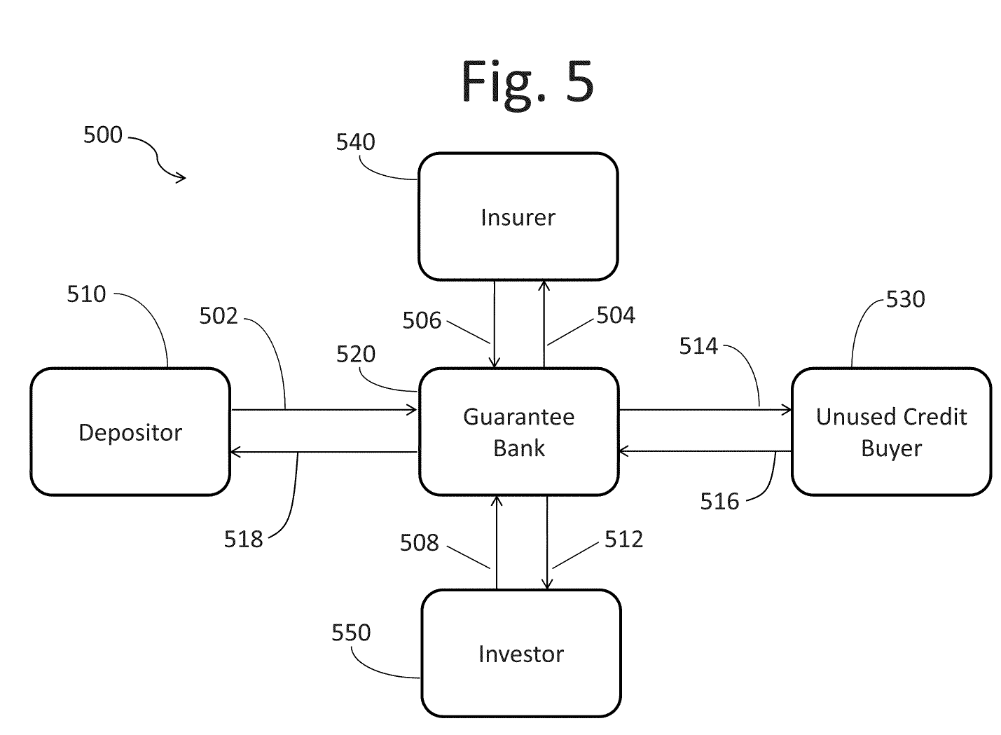

FIG. 5 is a schematic depicting an example of an arrangement 500 for structuring unused credit guarantees in which the unused credit guarantees are tailored to reduce default risk. The arrangement 500 includes a depositor 510, a financial institution 520, and an unused credit guarantee buyer 530. The financial institution 520 can register unused credit received from depositor 510 as unused credit guarantees and/or serve as a repository (e.g., bank, exchange, fund) for unused credit guarantees provided by the depositor 510. The arrangement 500 also includes one or more insurance providers 540 and/or one or more investors 550. Similar to the schematic of FIG. 2, each of the depositor 510, buyer 530, insurer 540, and investor 550 can include one or more client devices that are operable to communicate with one or more servers operated by the financial institution 520. When referring to actions by the depositor 510, buyer 530, insurer 540 or investor 550, it is understood that the client device (or client devices) associated with the corresponding entity performs the stated actions. Similarly, it is understood that actions by the financial institution 520 are performed by the one or more servers associated with the financial institution 520.

As shown in FIG. 5, the depositor 510 submits a request 502 to deposit unused credit with the financial institution 520. Using one or more server devices, the financial institution 520 registers the unused credit as an unused credit guarantee. To enhance the security of the guarantee, the financial institution 520 may obtain insurance 506 on the guarantee from the insurer 540. For example, a request 504 for insurance is issued from a server operated by the financial institution 520 to a client device operated by the insurer 540. The request 504 can include a payment or instructions/agreement to issue a charge for the insurance. The payment may be submitted electronically from the financial institution 520 over a network and to the client device operated by the insurer 540. The request 504 also can include information about the unused credit guarantee that can be used to determine the amount of insurance to be provided and/or the payment to be charged in return for the insurance coverage. The insurance 506 can include guarantee deposit insurance and/or financial guarantee insurance. Guarantee deposit insurance is insurance that guarantees a portion of the liability that the financial institution 520 has to the depositor 510 to either release an unused credit guarantee and/or to pay compensation to the depositor 510. Financial guarantee insurance is the insurance that the financial institution 520 can take to protect itself from a default by the depositor 510 and/or a third party buyer of unused credit guarantees. The insurance 506 can cover a specified amount of the unused credit guarantee. For example, the insurance 506 can cover up to 100% of the unused credit (e.g., up to 30%, 40%, 50%, 60%, 70%, 80%, or 90% of the unused credit value).

The financial institution 520 also can enhance the security of the unused credit guarantee by obtaining additional capital to back the guarantee. In some implementations, the financial institution 520, itself, provides the additional capital. Alternatively, or in addition, the financial institution 520 receives the additional capital from a separate investor 550 in exchange for compensation. Such capital can include junior risk capital or senior risk capital. In the example of FIG. 5, the financial institution 520 may issue a request for capital to the investor 550. Upon receiving the request, the investor 550 may agree to provide capital to the financial institution 520 and issue a capital payment 508 to the financial institution 520. The capital payment 508 can be issued electronically over a network from a client device operated by the investor 550 to a server operated by the financial institution 520. In return, the financial institution 520 can provide compensation 512 to the investor 550. For example, the compensation 512 can be in the form of an interest payment, in which the interest payment corresponds to a percentage of profits earned from the unused credit guarantee once sold to a buyer. The compensation 512 can be made in a single installment or over multiple installments.

Upon receiving the insurance and/or additional capital, the financial institution 520 may incorporate the recently obtained insurance and capital together with the unused credit guarantee to provide a structured unused credit guarantee 514. In some implementations, the financial institution 520 can assign a risk level to the structured unused credit guarantee 514. For example, based on the amount of insurance and/or capital added to the unused credit guarantee, the financial institution 520 may calculate a corresponding credit rating representative of the risk associated with the structured unused credit guarantee and assign that credit rating to the guarantee. Subsequent to completing the structuring, the server 220 registers the unused credit in an electronic deposit account associated with a list of marketable products it has created. In general, the unused credit deposit account can be stored in a database (e.g., an unused credit deposit account database) on the server 220 or coupled to the server 220. Access to this database may be granted for reporting and monitoring purposes to the depositor 510, the investor 550, the insurer 540 and the unused credit buyer 530.

The structured guarantee 514, which is now backed by insurance and/or additional capital, then is made available to third parties. For example, the structured unused credit guarantee 514 can be included in a list of unused credit guarantees that is made available to third parties, e.g., displayed on a website or included in an electronic communication to a third party. In some implementations, the structured guarantee 514 is issued by the financial institution 520 to the third party 530 in exchange for compensation 516. A portion of the proceeds obtained from selling the structured guarantee 514 to the buyer 530 then can be returned to the depositor 510 in the form of compensation 518. For example, the compensation 518 provided to the depositor 510 can include, but is not limited to, a recurring payment, a one-time payment, a payment corresponding to a percent interest of the value of unused credit deposited with the request 502, a predetermined payment having a fixed value independent of the value of unused credit deposited with request 502, a dividend payment, or an interest free loan. Though the compensation 518 is shown in FIG. 5 as being delivered to depositor 510, this can include electronically issuing the compensation 518 to a financial account operated by a client device under the control of depositor 510 or issuing the compensation 518 to a financial account associated with the depositor 510, in which the financial account is maintained by an entity separate from the depositor 510. In addition, delivering compensation 518 to depositor 510 also can include issuing a notification (e.g., an e-mail message, text message, or short messaging service (SMS) message) to a client device operated by the depositor 510, in which the notification informs the depositor 510 that compensation has been distributed. In some implementations, compensation 518 is not in the form of a payment or loan to a financial account, but is in the form of a gift. For example, compensation 518 can include a gift card that the depositor 510 can exchange for goods or services. Similarly, compensation 518 can include a gift code (e.g., coupon code, promotional code, discount code) that can be entered in a website in exchange for a financial discount or rebate when purchasing a product. In another example, compensation 518 can include products or services, such as a free electronic device, free airline tickets, or free vacation packages, among others. For gifts that cannot be sent electronically to a client device operated by the depositor 510 (e.g., tangible items such as gift cards and electronic devices), issuing compensation 518 can include electronically sending the depositor a receipt or notification that the compensation (e.g., the gift) has been or will be delivered.

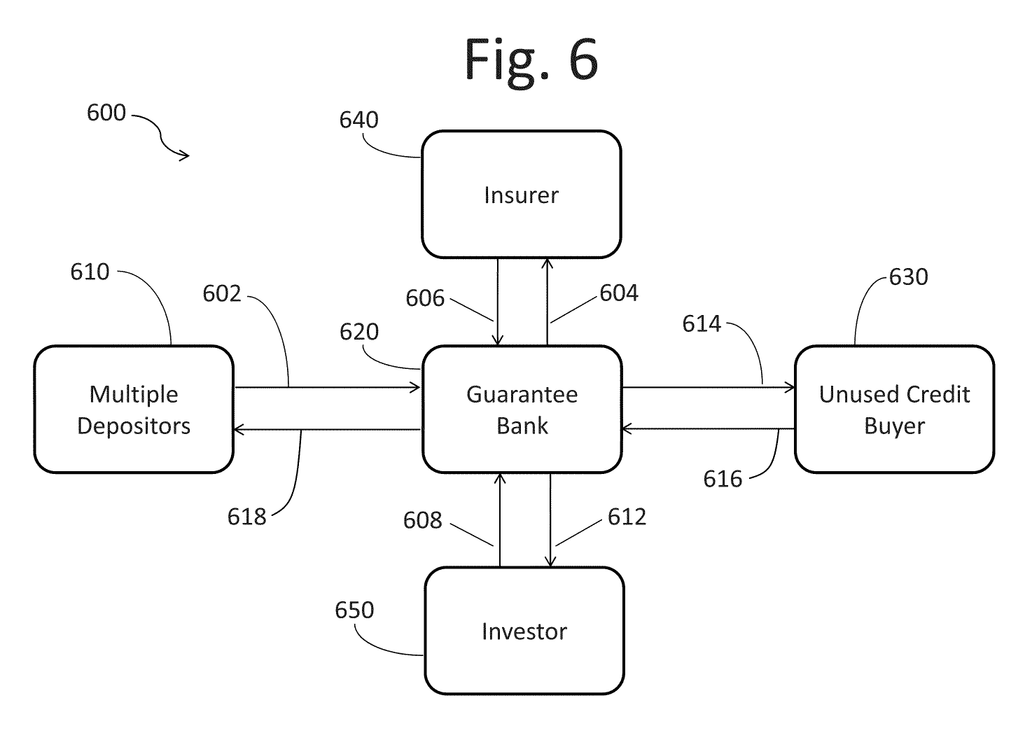

As explained above, in some implementations, a structured unused credit guarantee also can include an aggregated unused credit guarantee. The aggregated unused credit guarantee corresponds to a guarantee that is based on multiple unused credit guarantees, each of lesser value than the whole. FIG. 6 is a schematic of an arrangement 600 for providing an aggregated unused credit guarantee. The arrangement 600 includes multiple depositors 610, a financial institution 620, and an unused credit guarantee buyer 630. The arrangement 600 can optionally include one or more insurance providers 640 and/or one or more investors 650. Similar to the schematic of FIG. 2, each of the depositor 610, buyer 630, insurer 640, and investor 650 can include one or more client devices that are operable to communicate with one or more data processing devices (e.g., server devices) operated by the financial institution 620.

The financial institution 620 can register unused credit received from depositors 610 as unused credit guarantees and/or serve as a repository (e.g., bank, exchange, fund) for unused credit guarantees provided by the depositors 610. In the example of FIG. 6, one or more server devices operated by the financial institution 620 receive multiple requests 602 from the depositors 610 (e.g., from client devices operated by the depositors 610). Each of the requests 602 corresponds to a request to deposit unused credit with the financial institution 620. Subsequent to validation, the financial institution 620 registers the unused credit from each request as an unused credit guarantee in a corresponding deposit account. Two or more of the multiple unused credit guarantees then are combined into an aggregated unused credit guarantee 614. That is, the total unused credit value of an aggregated guarantee corresponds to the sum of the values associated with each individual unused credit guarantee used to compose the aggregated guarantee. For example, an aggregated unused credit guarantee can be composed of a first individual unused credit guarantee obtained for a first party and a second individual unused credit guarantee obtained for a second party. If the unused credit value of the first individual guarantee is $1,000 and the unused credit value of the second individual guarantee is $5,000, then the unused credit value of the aggregated guarantee is $6,000. Each aggregated unused credit guarantee can be registered in an aggregated guarantee database 625. Multiple aggregated unused credit guarantees are possible so long as each is composed of two or more individual unused credit guarantees.

Determination of which unused credit guarantees will be combined and how many unused credit guarantees are combined can be based on various factors. For example, in some implementations, the total number of unused credit guarantees that are combined into an aggregated guarantee is set based on a user-defined number (e.g., 10, 50, 100, 200, or 500 unused credit guarantees). In some implementations, the aggregated guarantee can be composed of unused credit guarantees having valuations in a single price range (e.g., between $1 and $1,000, between $1,000 and $10,000, between $10,000 and $50,000, between $50,000 and $100,000, or between $100,000 and $250,000). In some implementations, the aggregated guarantee can have a tiered composition based on the amount of unused credit associated with individual guarantees. For example, an aggregated guarantee can be composed of 25% of unused credit guarantees each having an unused credit valuation less than $10,000, 25% of unused credit guarantees each having an unused credit valuation between $10,000 and $50,000, 25% of unused credit guarantees each having an unused credit valuation between $50,000 and $100,000, and 25% of unused credit guarantees each having an unused credit valuation greater than $100,000. In some implementations, aggregated guarantees can be composed on the basis of the credit worthiness of depositors. For example, a first type of aggregated guarantee can be structured to include individual guarantees from depositors that only have the highest credit rating for the depositor class (e.g., Aaa or AAA credit rating for corporate class depositors, or above 800 for individual depositors). In another example, a second type of aggregated guarantee can be structured to include individual guarantees having different credit ratings in a fixed apportionment (e.g., 25% of unused credit guarantees from individual depositors having a credit rating between 650-699, 25% of unused credit guarantees from individual depositors having a credit rating between 700-750, 25% of unused credit guarantees from individual depositors having a credit rating between 750-799, and 25% of unused credit guarantees from individual depositors having a credit rating above 800). Other aggregated guarantee compositions are possible as well such as but not limited to combinations based on selections made by industry, location, and risk apatite of the depositors 510.

The financial institution 620 can further structure the aggregated guarantee 614 to reduce risk. For example, to enhance the security of the aggregated guarantee, the financial institution 620 may obtain insurance 606 (e.g., deposit insurance and/or financial guarantee insurance) on the guarantee from the insurer 640 in return for a payment 604. The financial institution 620 would then combine an insurance guarantee with the aggregated financial guarantee to produce an insurance-backed aggregated financial guarantee. Alternatively, or in addition, the financial institution 620 can obtain additional asset guarantees (e.g., capital investment) to back the aggregated guarantee. The financial institution 620 would then combine the asset guarantee with the aggregated financial guarantee to produce an asset-backed aggregated financial guarantee. For example, the financial institution 620 can issue compensation 612 to an investor 650 in return for capital 608 (e.g., junior risk capital or senior risk capital), in which the compensation 612 corresponds to a percentage of profits earned from selling the aggregated guarantee to a buyer or just a fee based on the capital invested by them

The aggregated structured guarantee 614, which is now backed by insurance and/or additional capital, then is made available to third parties. For example, the structured unused credit guarantee 614 can be issued by a server to the third party 630 in exchange for compensation 616. A portion of the proceeds obtained from selling the structured guarantee 614 to the buyer 630 then can be returned to the depositor 610 in the form of compensation 618. The compensation 618 provided to the depositor 610 can include, for example, a recurring payment, a one-time payment, a payment corresponding to a percent interest of the value of unused credit deposited with the request 602, a predetermined payment having a fixed value independent of the value of unused credit deposited with request 602, a dividend payment, an interest free loan, or a gift.

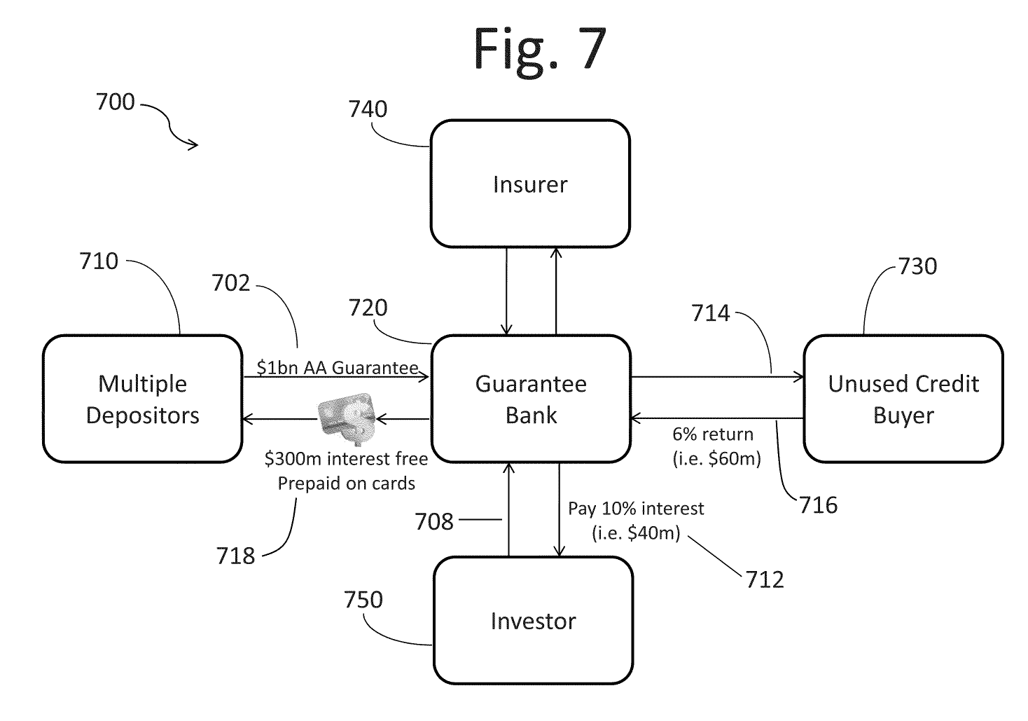

Instead of borrowing capital from investors for the purpose of reducing the risk associated with a particular unused credit guarantee, the financial institution can also employ unused credit for the purpose of scaling capital funding. That is, the financial institution can use income obtained in return from marketing the unused credit to increase the financial institution's capital. FIG. 7 is a schematic depicting an example arrangement 700 in which a financial institution employs unused credit to scale capital funding. As in previous examples, the arrangement 700 includes unused credit depositors 710, a financial institution 720, such as a bank or exchange, an insurance provider 740 and an investor 750. Similar to the schematic of FIG. 2, each of the depositors 710, insurer 740, and investor 750 can include one or more client devices that are operable to communicate with one or more data processing devices (e.g., server devices) operated by the financial institution 720.

In the present example, depositors 710 provide their unused credit to the financial institution 720, which in turn registers the unused credit as guarantees and combines the individual guarantees into one or more aggregated unused credit guarantees. Alternatively, the financial institution 720 can serve as a repository (e.g., bank, exchange, fund) for unused credit guarantees 702 provided by the depositors 710. For example, the depositors 710 may correspond to businesses that deposited unused credit having an equivalent value of one billion dollars, in which the businesses each have a credit rating of AA or higher. The one billion dollars in unused credit then is combined into an aggregated unused credit guarantee. The financial institution 720 then may reduce the default risk associated with the aggregated guarantee by purchasing insurance (e.g., 90% of the aggregated guarantee value). Though not shown, the financial institution 720 may also reduce the default risk by backing the aggregated guarantee with additional capital. The financial institution 720 then markets the structured aggregated guarantee 714 to 730 in exchange for a return 716 (e.g., 6% of the overall aggregated guarantee value or $60 million). The financial institution 720 then obtains/receives a loan 708 (e.g., $400 million) from the capital investor 750 and uses a portion (e.g., 10% of the loan or $40 million) of the return 716 to pay interest 712 on the loan. The financial institution 720 then may keep a portion (e.g., $100 million) of the loan 708 to improve capital reserves while distributing the balance ($300 million) of the loan 708 as compensation 718 to depositors 710. Alternatively, or in addition, the financial institution 720 may obtain/receive a second loan that is backed by a portion of the loan 708 received from the capital investor 750. The financial institution 720 then can take a portion of this second loan and also add it to the financial institution's capital reserves. In the example shown in FIG. 7 this compensation is in the form of interest free loans but other forms of compensation are also possible including, but not limited to, a fixed or variable fee, an interest payment (e.g., where the interest rate is based on the amount of unused credit), a dividend payment, or a capital gain payment. If cash payments are to be made as compensation instead of interest free loans as in the example of FIG. 7, then the financial institution 720 may obtain a lower loan amount (e.g. $100 million) from the capital investor and use a portion (e.g. 10% of the loan or $10 million) of the return to pay interest on the loan. The financial institution 720 may then keep the full amount of the loan to improve capital reserves while distributing a portion of the remaining return (e.g., $30 million) as compensation to the multiple depositors. Variations on this implementation are possible as well. For example, the financial institution 720 may use a portion of the return 716 as part of the compensation 718. An advantage of the foregoing arrangement is that the generation of capital reserves increases with the requirements for the reserve capital.

In some implementations, unused credit can be employed in repurchase agreement (also known as Repo) transactions. In a typical repurchase agreement (or sale and buy back) transaction, an owner sells an asset to an investor on a cash-basis and immediately buys it back on a longer-term basis, using the asset as collateral such that the owner obtains a cash loan at a fixed rate of interest. Similarly, unused credit can be employed in place of the asset and sold to an investor (e.g., a financial institution) that receives the unused credit as an unused credit guarantee or converts unused credit into unused credit guarantees. The depositor agrees to simultaneously or subsequently buy back the unused credit at a lower price than it sold it for, which would yield a benefit of receiving a return on its unused credit.

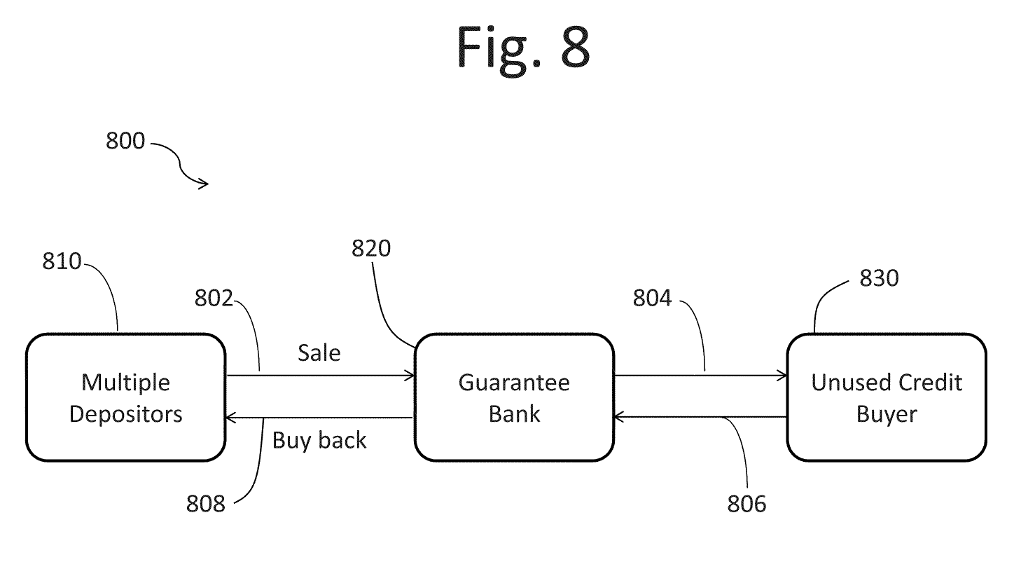

FIG. 8 is a schematic of an example arrangement 800 for performing a repurchase agreement with unused credit among three entities: depositors 810, a financial institution 820 and buyer 830. The financial institution 820 can register unused credit received from depositors 810 as unused credit guarantees and/or serve as a repository (e.g., bank, exchange, fund) for unused credit guarantees provided by the depositors 810. For simplicity, the entities which help enhance unused credit guarantees are not shown. When referring to actions by the depositor 810, the financial institution 820, and the buyer 830, it is understood that the client device (or client devices) associated with the corresponding entity performs the stated actions. In the present example, the depositor 810 (e.g., individual, bank, corporation or fund) sells unused credit 802 to a financial institution 820. The financial institution 820 gives the depositor 810 a bond or periodic payments 808. When the repurchase agreement is completed the depositor 810 buys back the unused credit 802 as agreed from the financial institution 820 for a fixed price. The financial institution 820 returns the unused credit 802 to the depositor 810. The financial institution 820 registers and structures the unused credit guarantees 804 (e.g., aggregated or non-aggregated unused credit guarantee) that are in its possession and these are then sold to buyers 830 in a market. The buyers 830 pay a fee 806 for the unused credit guarantee 804.

In some implementations, unused credit can be employed in options contracts, such as put or call option contracts between a buyer and a seller. A typical call option gives the buyer the right, but not the obligation to buy a particular quantity of an asset at a particular price at a particular time. A typical put option gives the buyer the right, but not the obligation to sell to the seller a particular quantity of an asset at a particular price at a particular time. Similarly, unused credit can be employed in place of the asset in both call and put options. Exact specifications may differ depending on the details of the underlying unused credit contracts. As an example, the unused credit may first be converted into an unused credit guarantee such that the first party of the guarantee (the seller) agrees to deliver to the second party (the buyer) an assignable unused credit guarantee, which the second party may use to cover certain risks only and which may be drawn upon in the event of potential losses from those risks. This unused credit guarantee then forms the underlying in place of the assets for the option contracts above. In this case a first party (e.g., a seller such as an individual, corporation, bank or fund) may sell (write) an unused credit put option to a second party (e.g. a buyer such as an unused credit guarantor or financial institution). That is, in exchange for a payment from a second party, the first party has sold the right, for a period of time, to the second party for the second party to make the first party deliver to the second party an unused credit guarantee contract in which the first party has given an assignable unused credit guarantee to the second party for a fixed price. If the second party does exercise its right to buy this unused credit, the second party is free to apply the unused credit in the manner agreed in the option contract (e.g., to assign the unused credit to certain risks only and to be able to draw upon the unused credit in the event of losses from those risks). An equivalent transaction is for the second party to buy an unused credit put option from the first party.

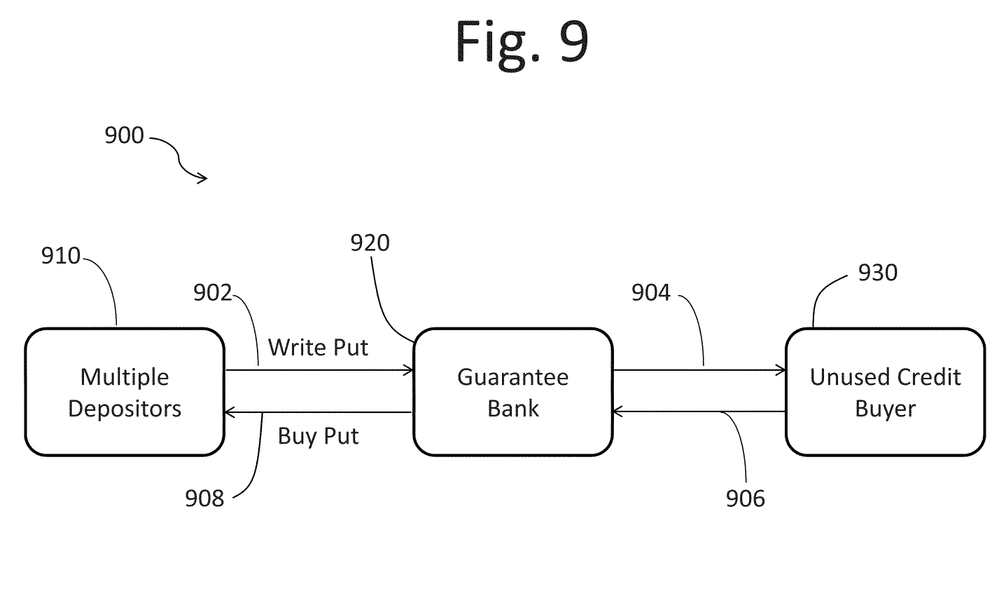

FIG. 9 is a schematic of an example arrangement 900 for performing unused credit write put and unused credit buy put transactions. The arrangement 900 includes at least three entities: an investor 910, a financial institution 920 and an unused credit guarantee buyer 930. When referring to actions by the depositor 910, the financial institution 920, and a buyer 930, it is understood that the client device (or client devices) associated with the corresponding entity performs the stated actions. The investor 910 is similar to depositor in the previous examples. However, the investor 910 does not necessarily make an unused credit deposit with the financial institution 920. In the present example, the financial institution 920 serves as a repository for unused credit guarantee guarantees. The first investor 910 (e.g., one or more individuals, banks, corporations or funds) writes an unused credit put 902 and sells this to the financial institution 920. That is, the first investor 910 has sold, in exchange for a payment from the financial institution 920, the right, for a specified period of time, for the financial institution 920 to make the investor 910 provide an unused credit guarantee contract for a fixed price. This is the same as the financial institution 920 buying a put 908 from the investor 910. The financial institution 920 then may further structure and sell aggregated or non-aggregated unused credit guarantees 904 with which the institution 920 has the option to purchase upon exercising unused credit option contract 902 to unused credit buyers 930 in exchange for a fee 906.

In some implementations, unused credit can be employed in back-to-back loans. In a typical back-to-back loan, two parties, each from a different country, borrow offsetting amounts from one another in each other's currency to hedge against currency fluctuations. Unused credit can be employed in a similar manner, with the exception that an unused credit guarantee is used in place of the loan.

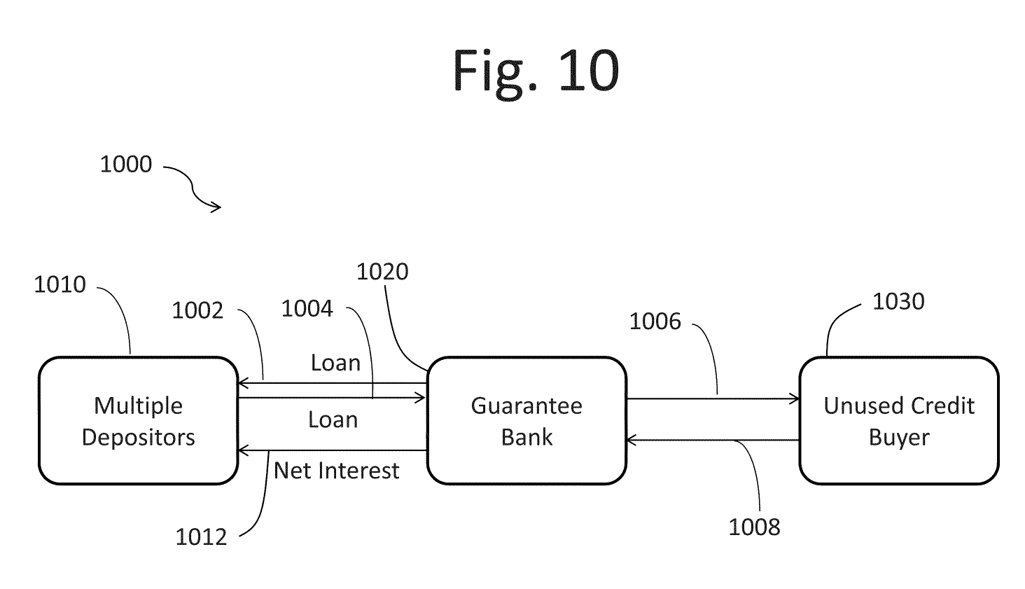

FIG. 10 is a schematic of an example arrangement 1000 for performing a back-to-back loan with unused credit guarantees. The arrangement 1000 includes at least three entities: an investor 1010, a financial institution 1020 and an unused credit guarantee buyer 1030. When referring to actions by the investor 1010, the financial institution 1020, and an unused credit buyer 1030, it is understood that the client device (or client devices) associated with the corresponding entity performs the stated actions. Again, the investor 1010 does not necessarily make an unused credit deposit with the financial institution 1020, which serves as a “guarantee bank” for unused credit guarantees. In the arrangement 1000, the investor 1010 may be in possession of an unused credit guarantee. The investor 1010 can loan the unused credit guarantee 1002 to the guarantee bank 1020 where the value of the unused credit guarantee is denominated in a first currency. In return, the guarantee bank 1020 loans another unused credit guarantee 1004 to the investor 1010 for an amount equivalent to the first loan but denominated in a second currency. In turn, the unused credit guarantee 1002 can be structured to reduce risk (e.g., by obtaining insurance on the guarantee, backing the guarantee with additional capital, or aggregating the guarantee with other unused credit guarantees) and offered as a structured unused credit guarantee 1006 to a buyer 1030 in return for compensation 1008. It is not necessary, however, to structure the unused credit guarantee 1002 to reduce risk. In some implementations, the guarantee bank 1020 can simply offer the unused credit guarantee 1002 to a buyer 1030. A portion 1012 of the compensation 1008 obtained in return for the structured unused credit guarantee 1006 can then be returned to the investor 1010 (e.g., as net interest). In some implementations, the guarantee bank 1020, subsequent to receiving an unused credit deposit request, makes a cash loan of the same value to the depositor 1010, which then loans all or a portion of the cash back to the guarantee bank 1020 in exchange for some compensation.

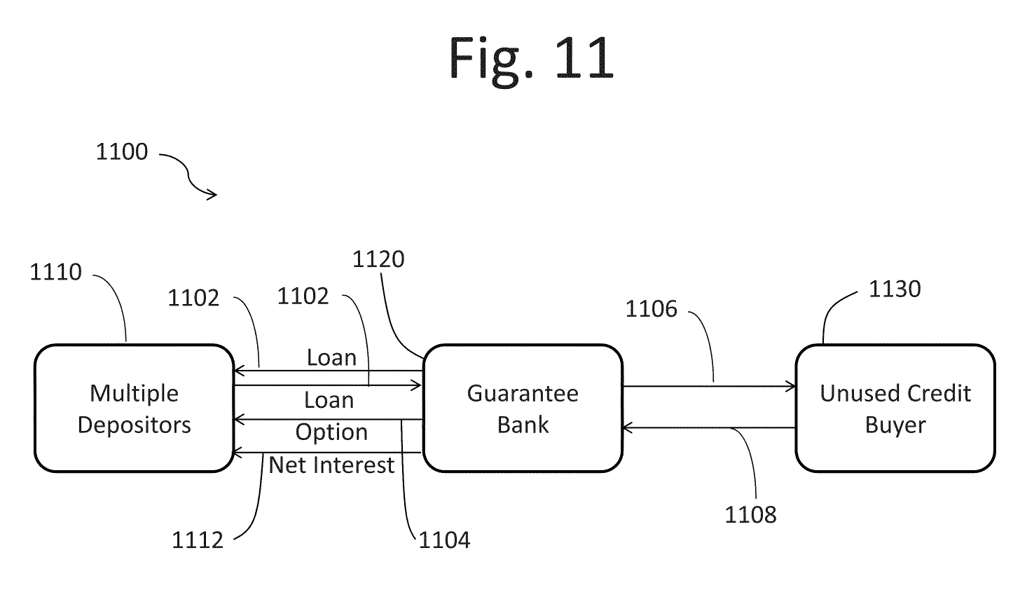

In some implementations, unused credit can be employed in hybrid financial transactions that include, but are not limited to, deposits, loans, option contracts, and derivatives. FIG. 11 is an example arrangement 1100 of a hybrid financial transaction employing unused credit. The arrangement 1100 includes at least three entities: an investor 1110, a financial institution 1120 (e.g., an unused credit guarantee bank) and an unused credit guarantee buyer 1130. When referring to actions by the investor 1110, the unused credit bank 1120, and an unused credit guarantee buyer 1130, it is understood that the client device (or client devices) associated with the corresponding entity performs the stated actions. Again, the investor 1110 does not necessarily make an unused credit deposit with the guarantee bank 1120, which acts as a repository for unused credit guarantee guarantees. In the arrangement 1100, the investor 1110 makes both a back-to-back loan 1102 of unused credit guarantees with the unused credit guarantee bank 1120, as well as obtains an option contract 1104 with the bank 1120. Upon selling an unused credit guarantee 1106 obtained from investor 1110 to a buyer 1130, the bank 1120 may return a portion 1112 of the compensation 1108 to investor 1110 (e.g., as net interest).

There are many other forms of hybrid structures, including those where the financial institution 1120 generates synthetic unused credit and or financial derivatives of unused credit. Synthetic unused credit guarantees essentially allow financial institutions (banks, hedge funds, and insurance firms) to benefit from the unused credit of a diversified portfolio of individuals or companies without directly purchasing the unused credit guarantees of those individuals or companies. Unlike the unused credit guarantees detailed above, synthetic unused credit guarantees are not guarantees based on any underlying unused credit. Instead, synthetic unused credit guarantees are, for the purposes of this disclosure, guarantees whose value is derived from an event associated with an unused credit guarantee, in which the unused credit guarantee may or may not be owned by the parties involved with the synthetic unused credit guarantee. For example, the value of a synthetic unused credit guarantee may be derived from insurance purchased against the default of a separate unused credit guarantee. Should a default occur with respect to the unused credit guarantee, the purchaser of the synthetic unused credit guarantee would receive compensation. The financial institution 1120 can generate such synthetic unused credit guarantees based on one or more unused credit guarantees that are available through the financial institution itself or through a third party, such as an exchange. The financial institution 1120 then can sell the generated synthetic to potential investors.

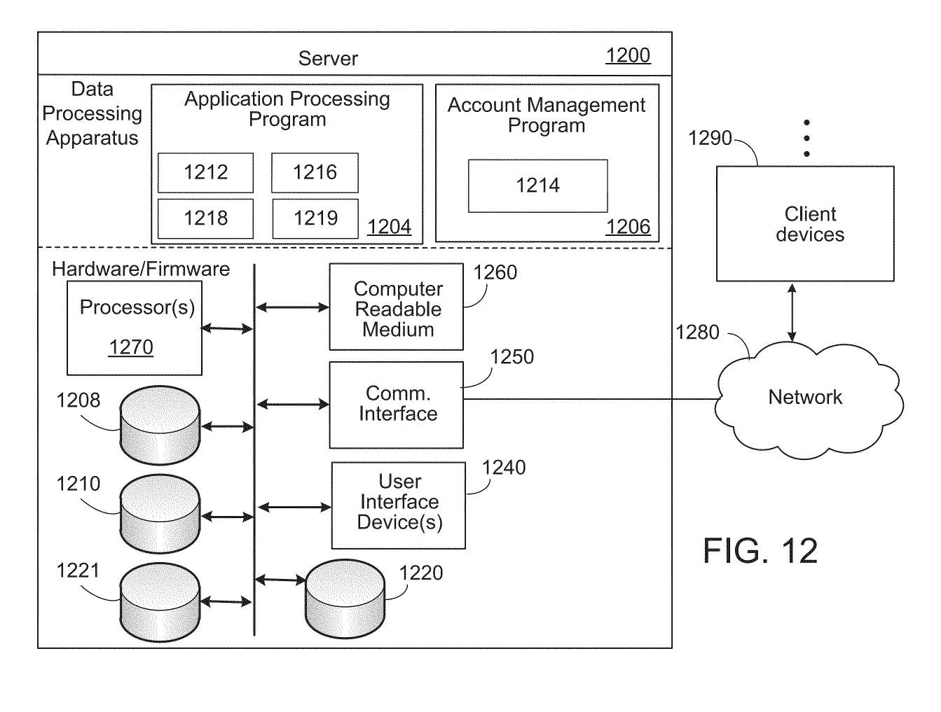

FIG. 12 is a schematic of a server device 1200 that can be used by a financial institution/unused credit guarantor/unused credit guarantee bank in any of the foregoing implementations or other implementations of the novel subject matter set forth in the present application. The server device 1200 is optionally connected to one or more user or client computer devices 1290 through a network 1280. The server device 1200 includes one or more data processing apparatuses. While only one data processing apparatus is shown in FIG. 12, multiple data processing apparatus can be used. The server device 1200 includes various software modules, e.g. executable software programs, libraries and/or rules engines. Although several software modules are illustrated, there may be fewer or more software modules. Moreover, the software modules can be distributed on one or more data processing apparatus connected by one or more networks or other suitable communication mediums. The server device 1200 also includes hardware or firmware devices including one or more processors 1270, computer readable medium 1260, a communication interface 1250, and one or more user interface devices 1240. Each processor 1270 is capable of processing instructions for execution within the server device 1200. Each processor 1270 is capable of processing instructions stored on the computer readable medium 1260 or on a storage device. The server device 1200 uses its communication interface 1250 to communicate with one or more computer devices 1290 (e.g., computer devices operated by a depositor, an insurer, an unused credit guarantee buyer, or an investor), for example, over the network 1280.

As shown in the example of FIG. 12, both an application processing and management module 1204 and an account management module 1206 run on the server device 1200. The application processing and management module 1204 receives unused credit deposit requests from client devices and processes requests to register unused credit as unused credit guarantees in deposit accounts. Formal applications for registering unused credit as unused credit guarantees can be portioned by the module 1204 into completed applications stored on database 1208 and active applications, which are not yet complete, stored on database 1210. For example, the application processing and management module 1204 can contain a receiving module 1212 operable to electronically receive multiple requests to deposit unused credit from one or more client devices through the communication interface 1250. The account management module 1206 can contain a guarantee registration module 1216 that interacts/communicates with the receiving module 1212, in which the module 1216 is operable to register the unused credit associated with the requests received by the module 1212 as unused credit guarantees. Application and program management module 1204 also can include an aggregation module 1214 that interacts/communicates with the guarantee registration module 1216, in which the module 1214 is operable to combine two or more unused credit guarantees into an aggregated financial guarantee. In evaluating requests to register unused credit, the application processing and management module 1204 can rely on one or more rules engines to make a determination as to whether a request should be granted. For example, the application processing and management module 1204 can rely on a fraud rules engine 1218, which checks credit references to determine a level of risk associated with the party making the request (e.g., determining whether there is a high probability that the party making the request will default or determining whether the amount of unused credit specified is a valid amount of unused credit available to the party). Information regarding credit worthiness can be obtained using the communication interface to communicate with one or more credit reference agencies module over? the network 1280. Alternatively, or in addition, the processing and management module 1204 can rely on an underwriting rules engine 1219 which determines underwriting requirements for registered unused credit guarantees including aggregated unused credit guarantees.

Account management module 1206 serves to manage the different unused credit guarantee deposit accounts and unused credit guarantee lending accounts stored in account database 1221. For example, account database 1221 can contain two separate databases: an unused credit account database configured to store unused credit guarantees and an aggregated financial guarantee database configured to store one or more aggregated financial guarantees. For example, the guarantee registration module 1216 can store the unused credit guarantees in the unused credit account database in different accounts corresponding to the clients from which the unused credit was obtained. The server device 1200 is operable to interact with one or more databases that store data for performing unused credit transactions such as, for example, an unused credit guarantee repository database 1220.

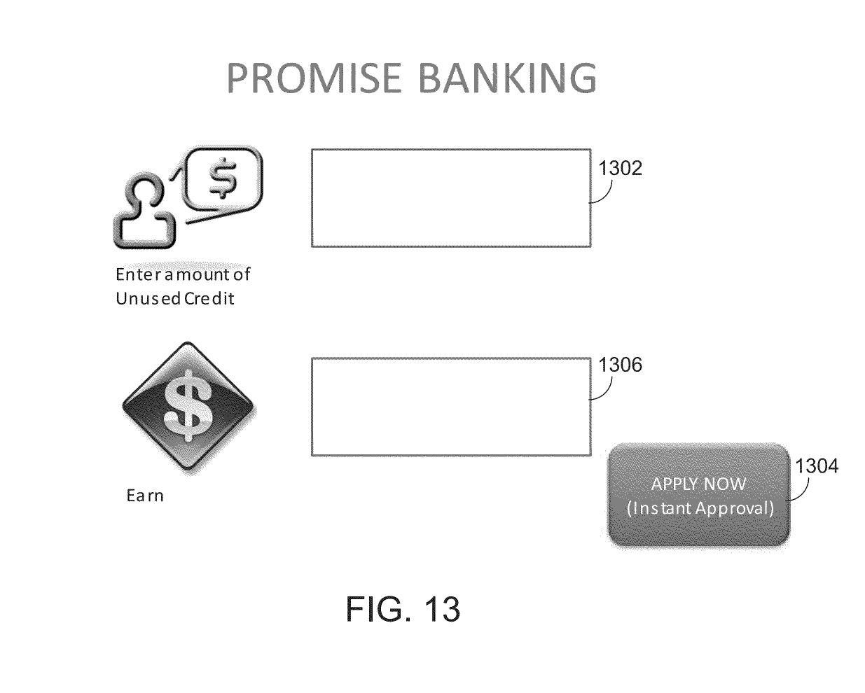

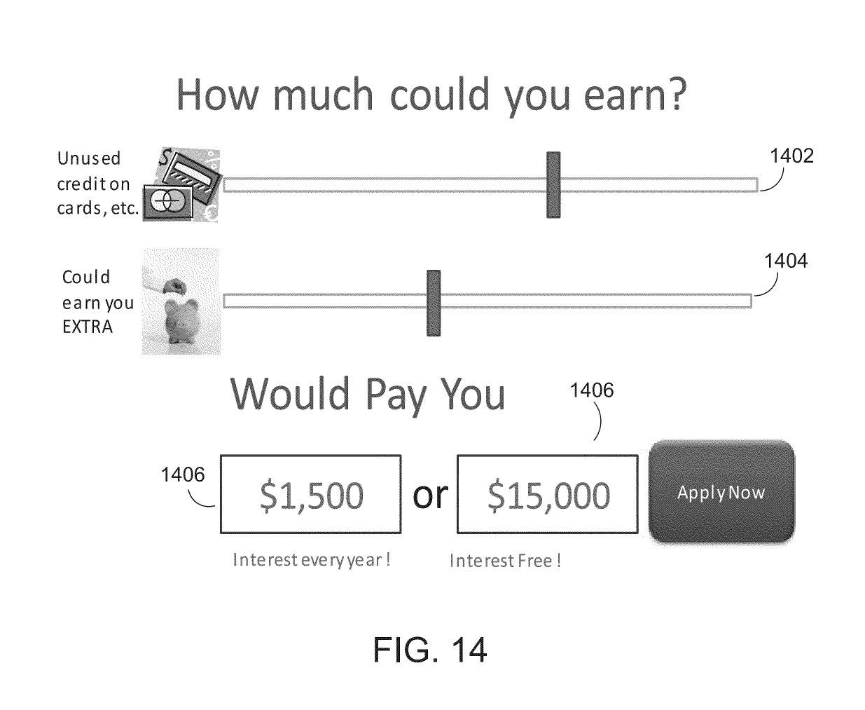

In some implementations, the server 1200 is configured to host a website that allows a user to perform unused credit financial transactions from any applicable computing device (e.g., a laptop, smartphone or, pad computing device). For example, the server device 1200 may host a website that can be accessed over the network 1280, in which the website displays interactive fields for entering information related to obtaining or registering unused credit guarantees. FIG. 13 is an example of a screenshot from an unused credit financial transaction website hosted, for example, by server device 1200. An interactive field 1302 allows a user to enter an amount of unused credit that the user desires to deposit with an unused credit guarantee bank. The website can be configured to calculate and display in field 1306 a potential amount of money that can be earned by a user depositing the unused credit entered into the interactive field 1302. The user may then press the interactive pushbutton 1304 to initiate the online application process. FIG. 14 is another example of a screenshot from an unused credit financial transaction website depicting scroll bars 1402, 1404. A user would adjust the unused credit scroll bar 1402 to vary the amount of unused credit they are considering depositing with a financial institution. The website can be configured to indicate, in response to the movement of scroll bar 1402, an amount of potential compensation that could be earned for depositing the specified amount of unused credit (e.g., through automatic movement of scroll bar 1404). In addition, the website could include fields 1406 for displaying the exact amount of compensation (e.g., interest payments or interest free loans) that can be earned by a user depositing a particular amount of unused credit.

Additional Implementation Details

Embodiments of the subject matter and the operations described in this specification, such as the client and server devices, can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. In some embodiments, the relationship of client and server can arise by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, in some implementations, a third party can include an unused credit deposit exchange. The unused credit exchange can include one or more computing devices that store one or more unused credit guarantee repositories with which other parties can identify and obtain aggregated unused credit guarantees for purchase.

In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
one or more computers operable to:
electronically receive a request to deposit a first unused credit guarantee with a financial institution; and
an unused credit account database configured to store the unused credit guarantee in a corresponding electronic account.

2. The system of claim 1, wherein the one or more computers are further operable to combine the first unused credit guarantee with at least one additional unused credit guarantee into an aggregated financial guarantee.

3. The system of claim 2, further comprising an aggregated financial guarantee database configured to store the aggregated financial guarantees.

4. The system of claim 2, wherein the one or more computers are further operable to electronically exchange, with a computing device, at least one of the aggregated financial guarantee or the first unused credit guarantee in return for a payment.

5. The system of claim 4, wherein the payment is selected from the group consisting of a periodic interest payment based on a value of the aggregated financial guarantee, a profit based on investment of the aggregated financial guarantee into an asset, a loan, and combinations thereof.

6. The system of claim 2, wherein the one or more computers are further operable to combine an insurance guarantee with the aggregated financial guarantee or the first unused credit guarantee to produce an insurance-backed unused credit guarantee.

7. The system of claim 2, wherein the one or more computers are further operable to combine an asset guarantee with the first unused credit guarantee or the aggregated financial guarantee to produce an asset-backed unused credit guarantee.

8. The system of claim 2, wherein the one or more computers are operable to issue the first unused credit guarantee or the aggregated financial guarantee to an account associated with an unused credit guarantee repository.

9. The system of claim 2, wherein the one or more computers are operable to:
add a first portion of the payment to a capital reserve of a financial entity;
receive a loan backed by a second portion of the payment; and
add a portion of the loan to the capital reserve of the financial entity.

10. The system of claim 1, wherein, in exchange for receiving the request to deposit the first unused credit guarantee, the one or more computers are further operable to electronically issue a payment to at least one electronic financial account.

11. The system of claim 10, wherein the at least one electronic financial account is associated with an entity having a credit rating on which at least a portion of the unused credit is derived.

12. The system of claim 10, wherein the payment comprises a loan.

13. The system of claim 10, wherein the loan is an interest-free loan.

14. The system of claim 1, wherein the one or more computers are further operable to electronically issue a communication to a computing device in exchange for receiving the request, the communication comprising a notice of a gift.

15. The system of claim 1, wherein the one or more computers are further operable to:
receive, from a computing device, a proposed amount of unused credit to deposit; and
provide to the computing device, in exchange for receiving the proposed amount of unused credit, a prospective return for depositing the proposed amount of unused credit with the financial institution.

16. The system of claim 1, wherein the one or more computers are operable to assign a credit rating to the first unused credit guarantee.

17. A computer-implemented method comprising:
electronically receiving from a first computing device a request to deposit a first unused credit guarantee with a financial institution; and
storing, using one or more processors, the first unused credit guarantee in a corresponding electronic account.

18. The computer-implemented method of claim 17, further comprising combining, using the one or more processors, the first unused credit guarantee with at least one additional unused credit guarantee into an aggregated financial guarantee.

19. The computer-implemented method of claim 18, further comprising exchanging, with the first computing device, at least one of the aggregated financial guarantee or the first unused credit guarantee in return for a payment.

20. The computer-implemented method of claim 19, wherein the payment is selected from the group consisting of a periodic interest payment based on a value of the aggregated financial guarantee, a profit based on investment of the aggregated financial guarantee into an asset, a loan, and combinations thereof.

21. The computer-implemented method of claim 18, further comprising combining, using the one or more processors, an insurance guarantee with the aggregated financial guarantee or the first unused credit guarantee to produce an insurance-backed unused credit guarantee.

22. The computer-implemented method of claim 18, further comprising combining, using the one or more processors, an asset guarantee with the first unused credit guarantee or the aggregated financial guarantee to produce an asset-backed unused credit guarantee.

23. The computer-implemented method of claim 18, further comprising issuing the first unused credit guarantee or the aggregated financial guarantee to an account associated with an unused credit guarantee repository.

24. The computer-implemented method of claim 18, further comprising:
adding a first portion of the payment to a capital reserve of a financial entity;
receiving a loan backed by a second portion of the payment; and
adding a portion of the loan to the capital reserve of the financial entity.

25. The computer-implemented method of claim 17, further comprising, in exchange for receiving the request to deposit the first unused credit guarantee, issuing a payment to at least one electronic financial account.

26. The computer-implemented method of claim 25, wherein the at least one electronic financial account is associated with an entity having a credit rating on which at least a portion of the unused credit is derived.

27. The computer-implemented method of claim 25, wherein the payment comprises a loan.

28. The computer-implemented method of claim 27, wherein the loan is an interest-free loan.

29. The computer-implemented method of claim 17, further comprising issuing, using the one or more processors, a communication to a computing device in exchange for receiving the request, the communication comprising a notice of a gift.

30. The computer-implemented method of claim 17, further comprising:
receiving, from the first computing device, a proposed amount of unused credit to deposit; and
providing to the first computing device, in exchange for receiving the proposed amount of unused credit, a prospective return for depositing the proposed amount of unused credit with the financial institution.

31. The computer-implemented method of claim 17, further comprising assigning, using the one or more processors, a credit rating to the first unused credit guarantee.

32. A computer storage medium encoded with a computer program, the program comprising instructions that when executed by data processing apparatus cause the data processing apparatus to perform operations comprising:
electronically receiving from a first computing device a request to deposit a first unused credit guarantee with a financial institution; and
storing, using one or more processors, the first unused credit guarantee in a corresponding electronic account.

33. The computer storage medium of claim 32, wherein the instructions, when executed by data processing apparatus, cause the data processing apparatus to perform operations further comprising combining the first unused credit guarantee with at least one additional unused credit guarantee into an aggregated financial guarantee.

34. The computer storage medium of claim 33, wherein the instructions, when executed by data processing apparatus, cause the data processing apparatus to perform operations further comprising exchanging, with the first computing device, at least one of the aggregated financial guarantee or the first unused credit guarantee in return for a payment.

35. The computer storage medium of claim 34, wherein the payment is selected from the group consisting of a periodic interest payment based on a value of the aggregated financial guarantee, a profit based on investment of the aggregated financial guarantee into an asset, a loan, and combinations thereof.

36. The computer storage medium of claim 33, wherein the instructions, when executed by data processing apparatus, cause the data processing apparatus to perform operations further comprising combining an insurance guarantee with the aggregated financial guarantee or the first unused credit guarantee to produce an insurance-backed unused credit guarantee.

37. The computer storage medium of claim 33, wherein the instructions, when executed by data processing apparatus, cause the data processing apparatus to perform operations further comprising combining an asset guarantee with the first unused credit guarantee or the aggregated financial guarantee to produce an asset-backed unused credit guarantee.

38. The computer storage medium of claim 33, wherein the instructions, when executed by data processing apparatus, cause the data processing apparatus to perform operations further comprising issuing the first unused credit guarantee or the aggregated financial guarantee to an account associated with an unused credit guarantee repository.

39. The computer storage medium of claim 33, wherein the instructions, when executed by data processing apparatus, cause the data processing apparatus to perform operations further comprising:
adding a first portion of the payment to a capital reserve of a financial entity;
receiving a loan backed by a second portion of the payment; and
adding a portion of the loan to the capital reserve of the financial entity.

40. The computer storage medium of claim 32, wherein the instructions, when executed by data processing apparatus, cause the data processing apparatus to perform operations further comprising, in exchange for receiving the request to deposit the first unused credit guarantee, issuing a payment to at least one electronic financial account.

41. The computer storage medium of claim 40, wherein the at least one electronic financial account is associated with an entity having a credit rating on which at least a portion of the unused credit is derived.

42. The computer storage medium of claim 40, wherein the payment comprises a loan.

43. The computer storage medium of claim 40, wherein the loan is an interest-free loan.

44. The computer storage medium of claim 32, wherein the instructions, when executed by data processing apparatus, cause the data processing apparatus to perform operations further comprising issuing a communication to a computing device in exchange for receiving the request, the communication comprising a notice of a gift.

45. The computer storage medium of claim 32, wherein the instructions, when executed by data processing apparatus, cause the data processing apparatus to perform operations further comprising:
receiving, from the first computing device, a proposed amount of unused credit to deposit; and
providing to the first computing device, in exchange for receiving the proposed amount of unused credit, a prospective return for depositing the proposed amount of unused credit with the financial institution.

46. The computer storage medium of claim 32, wherein the instructions, when executed by data processing apparatus, cause the data processing apparatus to perform operations further comprising assigning a credit rating to the first unused credit guarantee.
